(19) United States
(12) Patent Application Publication
(10) Pub. No.: US 2024/0074934 A1
(43) Pub. Date: Mar. 7, 2024

(54) BIOMETRIC SENSOR SYSTEMS AND CONTROL LOGIC FOR ACTIVE-PASSIVE ROBOTIC EXOSKELETONS

(71) Applicant: Motion Augmented LLC, Farmington Hills, CA (US)

(72) Inventors: Cameron Brandon Pinnock, Farmington, MI (US); Haroun Algahmi, Detroit, MI (US)

(73) Assignee: Motion Augmented LLC, Farmington Hills, MI (US)

(21) Appl. No.: 18/347,132

(22) Filed: Jul. 5, 2023

Related U.S. Application Data
(60) Provisional application No. 63/418,135, filed on Oct. 21, 2022.
(60) Provisional application No. 63/403,425, filed on Sep. 2, 2022.

(51) Int. Cl. A61H 1/02; A61H 3/00; B25J 9/00

(52) U.S. Cl. CPC A61H 1/024; A61H 1/0277; A61H 3/00; B25J 9/0006; A61H 2003/007; A61H 2201/1207; A61H 2201/1276; A61H 2201/1445; A61H 2201/1628; A61H 2201/1635; A61H 2201/164; A61H 2201/165; A61H 2201/5007; A61H 2201/5069; A61H 2201/5097; A61H 2230/00

(57) ABSTRACT

Disclosed herein are wearable, wireless-enabled biometric sensor systems, methods for manufacturing/operating such biometric sensor systems, and robotic exoskeletons equipped with such biometric sensor systems. A biometric sensor system includes a first biometric subassembly that mounts to an upper-extremity portion of a user's appendage, and a second biometric subassembly that mounts to a lower-extremity portion of the user's appendage. Each biometric subassembly includes a respective biometric sensor that monitors a biometric characteristic of the respective extremity portion of the user appendage and wirelessly outputs a sensor signal indicative thereof. A system central processing unit (CPU), which mounts onto the user, is programmed to receive sensor signals from the biometric sensors, calculate a biometric parameter of the user appendage using biometric characteristics indicated by the received sensor signals, and command a subsystem (e.g., exoskeleton joint assembly motor module) to execute one or more control operations based on the calculated biometric parameter.

### CLAIM OF PRIORITY AND CROSS-REFERENCE TO RELATED APPLICATIONS

This application claims the benefit of and priority to U.S. Provisional Patent Application No. 63/403,425, which was filed on Sep. 2, 2022, and U.S. Provisional Patent Application No. 63/418,135, which was filed on Oct. 21, 2022, both of which are incorporated herein by reference in their respective entireties and for all purposes.

### TECHNICAL FIELD

The present disclosure relates generally to wearable devices and systems for assisting with user motion. More specifically, aspects of this disclosure relate to wireless sensor systems for measuring dynamic motion of users to control robotic exoskeletons for assisting human motion and reducing energy expenditure during motion.

### BACKGROUND

Many exoskeletons on the market are used in medical rehabilitation and industrial applications that require heavy lifting or other atypical dynamic movements. The exoskeletons in both of these applications typically do not incorporate features that allow the wearers to use their own natural strength while healing or to quicky escape from danger while on the job. Even though a reason for using exoskeletons in this manner is to assist the wearer, the user may eventually wish to rely on their own strength without supplemental assistance, e.g., via an exoskeletal electric motor. Many applications may be directed to rehabilitation of minor injuries and for uninjured individuals that are using the exoskeleton system to conserve energy while doing tasks. In such applications, having the ability to walk or lift with assistance via a motor and, when desired, run or move freely without motor-assistance may be crucial in the engineering of an exoskeleton suit.

Exoskeletons may be controlled using a variety of different methods. For instance, an exoskeleton may be controlled autonomously via computer programmed software (e.g., in instances where the user is paralyzed from the waist down). Another method includes using walking sticks that have force sensors or motion sensors that work in cadence with the exoskeleton robot. In an example, electromyograph (EMG) and electroencephalograph (EEG) sensors may be employed to control the exoskeleton systems (e.g., for users that are partially or completely paralyzed from the waist down). Additionally, motion sensors may be employed to measure joint angles to aid in providing direction for the exoskeleton. Available types of biometric sensors that may be utilized in exoskeleton systems include, for example, motion joint angle sensors worn on the user's body, force sensors worn on the hands and feet, EMG sensors, and EEG sensors. However, many commercially available biometric sensors are costly, cumbersome, and/or contain many wires that complicate system assembly and can be inconvenient for the end user.

Exoskeleton technology has been in use experimentally since the mid-20th century and has since gained much traction. An example of a “Reconfigurable Exoskeleton” is presented in U.S. Patent App. Pub. No. 2015/0351995 A1, to Adam Zoss et al., which utilizes a modular joint system to enable reconfigurable exoskeleton limbs. The Zoss exoskeleton is a powered exoskeleton system that allows for limb actuation at the joints for assistance during walking. Even though this device is less bulky than many other available exoskeletons, it moves slowly and is only meant for rehabilitation purposes for individuals with lower extremity paralysis. Users are not able to run with the Zoss exoskeleton nor are they able to move with the system power off.

An example of a “Motorized Exoskeleton Unit” is shown in U.S. Patent App. Pub. No. 2013/0253385 A1, to Amit Goffer et al., which is designed for a lower body extremity. In this example, the exoskeleton's joints are motorized to allow for actuation of the lower limbs. Goffer's exo device is designed to assist someone while walking and for related bipedal locomotion. In addition, this device contains a motor that is only connected to a lower limb and does not contain a clutching mechanism to allow the individual the freedom to move on their own.

An example of a robotic “Wearing-Type Movement Assistance Device” is shown in U.S. Patent App. Pub. No. 2017/0144309 A1, to Yoshiyuki Sankai, which uses drive units to provision lift assistance using angle joint sensors to control the exoskeleton. Sankai's exoskeleton includes an upper limb assistance section jointed to a lower limb assistance section with motorized hip, shoulder, and elbow joints to aid someone while performing tasks. However, the exoskeleton drive motors in this design are permanent fixtures and, thus, are not readily attachable and removable by the end user. In addition, Sankai's sensors are not wireless and the exoskeleton system is not modular.

None of the above-described exoskeleton examples are hybrid passive-and-active robotic exoskeletons in which the end user can readily add and remove motor units or selectively engage and disengage the motor units when desired. Additionally, none of the above motorized exoskeleton examples utilize a clutch device for the selective transmission of power from the motor to actuate a limb to enhance the user's strength, nor are they being controlled via wireless sensor technology. All of the above discussed U.S. Patents and Patent Application Publications are incorporated herein by reference in their respective entireties and for all purposes.

### SUMMARY

Presented herein are exoskeleton systems with attendant control logic for assisting users with movement, power clutch transmissions for exoskeletons, articulating joint and appendage units for exoskeletons, modular motor units for exoskeletons, wireless biometric controls systems for exoskeletons, and methods for making and methods for operating disclosed exoskeletons, transmissions, motor units, appendage-joint assemblies, and/or biometric systems. In an example, there is presented a modular exoskeleton that is adaptable with modular motor unit attachments that increase a user's strength when electrically powered. When not powered, the exoskeleton is in a passive operating mode that allows the user to freely move without assistance. The user can detach the motor units and customize the passive exoskeleton to multiple different architectures. Disclosed exoskeleton systems may employ Internet of Things (IoT) technology, e.g., that uses Bluetooth Low Energy technology (BLE), to connect biometric sensors to a central processing unit (CPU) of the exoskeleton and, if desired, to other resident system devices.

Aspects of this disclosure are also directed to hybrid power clutch transmission devices, e.g., for an elbow/knee motor unit, a hip/shoulder motor unit, and/or other motorized limb units of an exoskeleton system. The hybrid transmission and attendant control scheme is enabled via one or more electromagnetic clutches that engage and take up torque capacity when powered to thereby initiate a strength-enhancing active operating mode of the exoskeleton system. When not powered, the electromagnetic clutch or clutches disengage and slip to enable a passive operating mode of the exoskeleton system. An optional hybrid operating mode may default to a passive-type operating mode and automatically trigger an active-type operating mode when wireless biometric sensors activate clutch engagement when increased muscle activity is predicted or sensed.

The weight-bearing structure of the exoskeleton system may include an exoskeleton frame, which may contain an upper body mechanical structure and/or a lower body mechanical structure. The exoskeleton frame may use high-strength magnetic ball-and-socket joints for the hip and shoulder joint regions, e.g., to increase range of motion via mimicking the same regions of the human body. A knee region of the exoskeleton frame structure may be spring loaded, e.g., via a torsion spring and/or a gas spring. A leg region of the exoskeleton frame structure may contain a magnetic sliding lock mechanism that can be used to lock a gas spring when disengaged; when engaged, the sliding lock mechanism may unlock the gas spring such that the user can bend their knee. The sliding lock mechanism may allow the wearer to hold a desired position without the associated motor(s) being powered.

The exoskeleton frame structure may be made active, at least in part, via the attachment of one or more computer-controlled motor units. When powered on, these motor units supplement user strength for the wearer of the exoskeleton system. Output of the motorized units may be governed by a system central processing unit (CPU) based on feedback from a distributed network of wireless biometric sensors. Biometric sensors that are used to control the exoskeleton system may include motion sensors for detecting angle positioning and EMG sensors for detecting muscle activity. A modular exoskeleton architecture that is designed to add one or more motor unit modules to enable an active robotic exoskeleton provides multiple uses for the wearer as well as various economic benefits. When set in a passive operating mode, the exoskeleton frame structure may assist the user with standing, squatting, or holding other positions, e.g., via mechanically locking parts of the exoskeleton. When set in an active operating mode, a user can add one or more motor units to aid in augmenting the wearer's movement and strength capabilities. This enables a user to purchase/integrate only those components that are needed, and to modify the exoskeletal functionality at any time, rather than being limited to buying/using either a passive exoskeleton or a robotic exoskeleton.

Disclosed motorized exoskeleton systems may contain one or more articulating joint assemblies, such as a knee module, each of which may be equipped with an electromagnetic clutch, e.g., for safety, increased freedom of movement, and decreased battery power consumption. Safety is a top priority for many applications when designing exoskeletons. For instance, a user may be protected from injury if a CPU error occurs because the system is able to decouple the motor from the limb. Also, the motor and the gears will be protected from damage if an error occurs. Increased freedom of movement may enable improved safety since disengaging the electromagnetic clutch or clutches enables the user to move without hinderance at their own speed and under their own control, e.g., to escape danger or to move faster. Unlike many commercially available motorized exoskeletons, in which the user can only move as fast as the exoskeleton motor allows them to move (e.g., due to engaged motor drag), disclosed exoskeleton systems help to enable both active and passive operation for unencumbered movement. Moreover, the ability to drivingly decouple the motor units reduces motor use with a concomitant reduction in energy consumption and wear; in so doing, the user can activate the exoskeleton system's assisted walking and lifting features when desired.

Attendant advantages for at least some of the disclosed concepts include modular motor unit designs that are structurally configured to be easily attached to an exoskeleton suit, providing an active exoskeleton architecture that enables assisted movement with enhanced strength via robotic actuation. At the same time, disclosed modular motor units are structurally configured to be easily detached from an exoskeleton suit, e.g., without specialized tooling or damaging the motor/suit, providing a passive exoskeleton architecture that enables the user to rely on their own strength and stamina, e.g., with the enhanced stability provided by the suit. To simplify motor attachment/detachment while reducing system cost, weight, and complexity, disclosed motor units may communicate wirelessly with on-board controllers and sensors. The modularity and interchangeability of the motor unit modules further reduces system complexity and manufacturing costs while optimizing cross-platform adaptability and improving end-user experience.

Aspects of this disclosure are directed to wearable, wireless-enabled biometric sensor systems. In an example, a biometric sensor system includes a first biometric subassembly that is structurally configured to mount to an upper-extremity portion of an appendage of a user, and a second biometric subassembly that is structurally configured to mount to a lower-extremity portion of the user's appendage. Each biometric subassembly includes a respective biometric sensor that is operable to monitor a biometric characteristic of the respective extremity portion of the user appendage and wirelessly output a sensor signal indicative thereof. The biometric sensor system also includes a system central processing unit (CPU) that is structurally configured to mount onto the user and is operable to wirelessly communicate with the biometric subassemblies. The system CPU is programmed to receive sensor signals from the biometric sensors and calculate a biometric parameter of the user's appendage using biometric characteristics that are indicated by the sensor signals received from the biometric sensors. The system CPU then transmits one or more command signals to a resident or remote subsystem to execute one or more control operations based on the calculated biometric parameter of the user appendage.

Additional aspects of this disclosure are directed to hybrid active-passive exoskeleton systems for assisting the movement of a user. As used herein, the terms “exoskeleton” and “exoskeleton system”, including permutations thereof, may be used interchangeably and synonymously to include any relevant exoskeleton platform, such as: medical exoskeletons, industrial exoskeletons, and combat exoskeletons; passive-type, active-type, and hybrid-type exoskeletons; fixed architectures, supported architectures, and mobile architectures; soft-suit and hard-suite designs; and full-body, lower-extremity, and upper-extremity exoskeletons, etc. In an example, an exoskeleton system includes an exoskeleton frame with at least one articulating joint assembly that attaches to an appendage of a user. One or more modular motor units each removably attaches to the exoskeleton frame and is selectively operable to transmit a motor torque to a respective joint assembly to thereby assist with movement of the appendage of the user.

Continuing with the preceding discussion, the exoskeleton system also includes a biometric sensor system with a first biometric subassembly that mounts to an upper-extremity portion of the user's appendage and includes a first biometric sensor that is operable to monitor a first biometric characteristic of the upper-extremity portion and wirelessly output a first sensor signal indicative thereof. The biometric sensor system also includes a second biometric subassembly that mounts to a lower-extremity portion of the user's appendage and includes a second biometric sensor that is operable to monitor a second biometric characteristic of the lower-extremity portion and wirelessly output a second sensor signal indicative thereof. A system CPU mounts onto the user and wirelessly communicates with the biometric subassemblies. The system CPU is programmed to receive the first sensor signal from the first biometric sensor and the second sensor signal from the second biometric sensor, and calculate a first biometric parameter of the first appendage using the first and second biometric characteristics indicated by the first and second sensor signals received from the first and second biometric sensors. The system CPU then transmits a command signal to a corresponding motor unit to output a motor torque and thereby change a motor position based on the calculated first biometric parameter.

Aspects of this disclosure are also directed to manufacturing workflow processes, computer-readable media, and control logic for making or for using any of the disclosed exoskeleton systems, modular motor unit assemblies, biometric sensor arrays, and/or other disclosed hardware and componentry. In an example, a method is presented for operating a biometric sensor system for a user with multiple appendages. This representative method includes, in any order and in any combination with any of the above and below disclosed options and features: mounting a first biometric subassembly to an upper-extremity portion of a first appendage of the user appendages, the first biometric subassembly including a first biometric sensor operable to monitor a first biometric characteristic of the upper-extremity portion of the first appendage and wirelessly output a first sensor signal indicative thereof; mounting a second biometric subassembly to a lower-extremity portion of the first appendage, the second biometric subassembly including a second biometric sensor operable to monitor a second biometric characteristic of the lower-extremity portion of the first appendage and wirelessly output a second sensor signal indicative thereof; mounting a system central processing unit onto the user; receiving, via the system CPU, the first sensor signal from the first biometric sensor and the second sensor signal from the second biometric sensor; calculating, via the system CPU, a first biometric parameter of the first appendage using the first and second biometric characteristics indicated by the first and second sensor signals received from the first and second biometric sensors; and transmitting, via the system CPU to a subsystem, a command signal to execute a control operation based on the calculated first biometric parameter.

For any of the disclosed systems, methods, and devices, the first biometric characteristic may be a first relative angle, the second biometric characteristic may be a second relative angle, and the first biometric parameter of the first appendage may be a joint angle of a joint of the first appendage. In this instance, the joint angle may be calculated as an absolute value of a mathematical difference between the first and second relative angles. As another option, the system CPU may also be programmed to receive a selection of a desired operating mode for the subsystem, which is selected from a group comprising an active mode and a passive mode. Responsive to the desired operating mode being the active mode, the system CPU may transmit a power-on command signal to the subsystem to transition to an active operating state.

For any of the disclosed systems, methods, and devices, the subsystem may include an electric motor, a position encoder, and a motor driver. In this instance, the control operation may include the position encoder determining a current position of the electric motor and the motor driver changing the current position of the electric motor based on the calculated first biometric parameter. As a further option, the control operation may include the motor driver moving the electric motor to an omega set point via systematically repeating a position convergence loop until a position convergence is achieved between the current position of the electric motor and the omega set point. The subsystem may also include a torque-transmitting clutch mechanism that is drivingly connected to the electric motor. In this instance, the control operation further includes activating the clutch mechanism to transmit torque received from the electric motor.

For any of the disclosed systems, methods, and devices, each biometric subassembly may include a biometric sensor motion module, which is operable to monitor one or more dynamic characteristics of the user's appendage, and a biometric sensor module, which is operable to monitor one or more physiological characteristics of the user's appendage. The biometric sensor system may also include a rechargeable energy storage device, such as a lithium-ion battery pack, that is structurally configured to mount onto the user and selectively power the system CPU. As a further option, the biometric sensor system may also include a waist biometric subassembly that is structurally configured to mount to a waist portion of the user. The waist biometric subassembly may include a biometric sensor that is operable to monitor a biometric characteristic of the user's waist portion and wirelessly output a sensor signal indicative thereof to the system CPU.

For any of the disclosed systems, methods, and devices, the biometric sensor system may also include a third biometric subassembly that is structurally configured to mount to an upper-extremity portion of a second appendage of the user, and a fourth biometric subassembly that is structurally configured to mount to a lower-extremity portion of the second appendage. Each of these biometric subassemblies includes a respective biometric sensor that is operable to monitor a biometric characteristic of the respective extremity portion of the user's second appendage and wirelessly output one or more sensor signals indicative thereof to the system CPU. As another option, each biometric subassembly may include a respective strap that mount thereto the biometric sensor; the strap is shaped and sized to immovably mount onto the respective extremity portion of the user's appendage. The user appendage may be an arm or a leg such that the upper-extremity portion is either a bicep portion of the arm or a thigh portion of the leg, and the lower-extremity portion is either a forearm portion of the arm or a tibia portion of the leg. In this instance, the joint of the appendage may be a shoulder joint, an elbow joint, a hip joint, or a knee joint.

The above Summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a front, perspective-view illustration of a representative full-body modular exoskeleton system in accord with aspects of this disclosure.

FIG. 2 is a partially exploded, front perspective-view illustration of the representative full-body modular exoskeleton system of FIG. 1 with controller-automated motor unit modules and wireless-enabled wearable sensor devices in accord with aspects of this disclosure.

FIG. 3 is a partially exploded, front perspective-view illustration of a representative biometric sensor system for use with a representative upper extremity exoskeleton in accord with aspects of this disclosure.

FIG. 4 is a partially exploded, rear perspective-view illustration of the representative biometric sensor system and upper extremity exoskeleton of FIG. 3.

FIG. 5 is a front-view illustration of a representative user wearing the representative biometric sensor system and upper extremity exoskeleton of FIG. 3.

FIG. 6 is a rear-view illustration of the representative user of FIG. 5 wearing the representative biometric sensor system and upper extremity exoskeleton of FIG. 3.

FIG. 7 is a schematic system diagram illustrating a representative wireless biometric sensor and motor unit to central device connection and control method in accord with aspects of this disclosure.

FIG. 8 is a schematic system diagram illustrating another representative wireless biometric sensor, motor unit, articulating joint, and motor-clutch to central device connection and control method in accord with aspects of this disclosure.

The present disclosure is amenable to various modifications and alternative forms, and some representative embodiments are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as exemplifications of the disclosed principles, not limitations of the broad aspects of the disclosure. To that extent, elements and limitations that are described, for example, in the Abstract, Technical Field, Background, Summary, and Detailed Description sections, but not explicitly set forth in the claims, should not be incorporated into the claims, singly or collectively, by implication, inference, or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example.

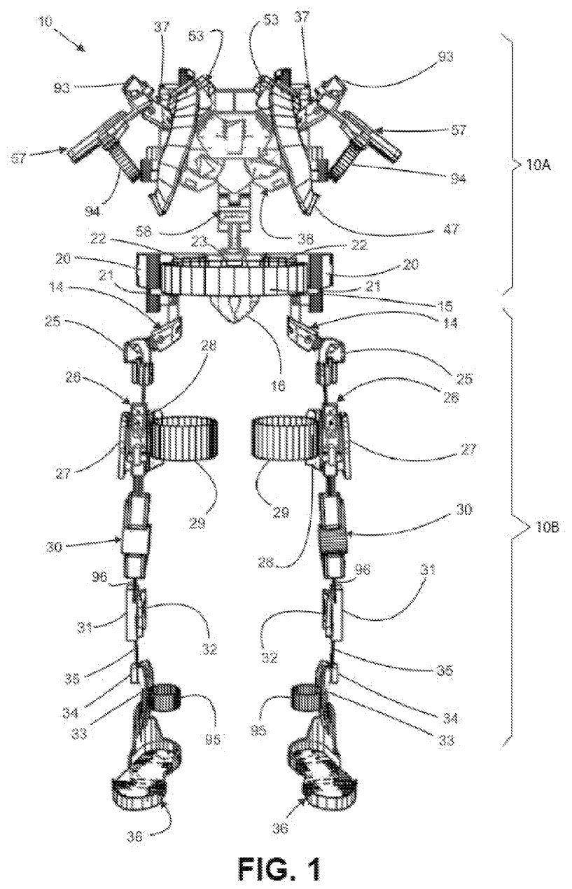

Referring now to the drawings, wherein like reference numbers refer to the same or similar features throughout the several views, there is shown in FIG. 1 a representative exoskeleton system, which is designated generally at 10 and portrayed herein for purposes of discussion as a modular, hybrid-type full-body exoskeleton structure for an “average” adult human. The illustrated full-body exoskeleton system 10—also referred to herein as “exoskeleton structure” or “exoskeleton” for short—is merely an exemplary application with which novel aspects of this disclosure may be practiced. As such, it will be understood that aspects and features of this disclosure may be implemented for any desired exoskeleton architecture (e.g., full-body, lower-extremity, upper-extremity, industrial, commercial, medicinal, combat, etc.), may be scaled and adapted for users of different sizes, shapes, and species, and may be implemented for any logically relevant exo and non-exo applications (e.g., professional athletes, amateur athletes, pedestrians, patients, etc.). Moreover, only select components of the exoskeleton systems and wearable sensor devices are shown and described in additional detail below. Nevertheless, the systems and devices discussed herein may include numerous additional and alternative features, and other available peripheral components, for carrying out the various methods and functions of this disclosure.

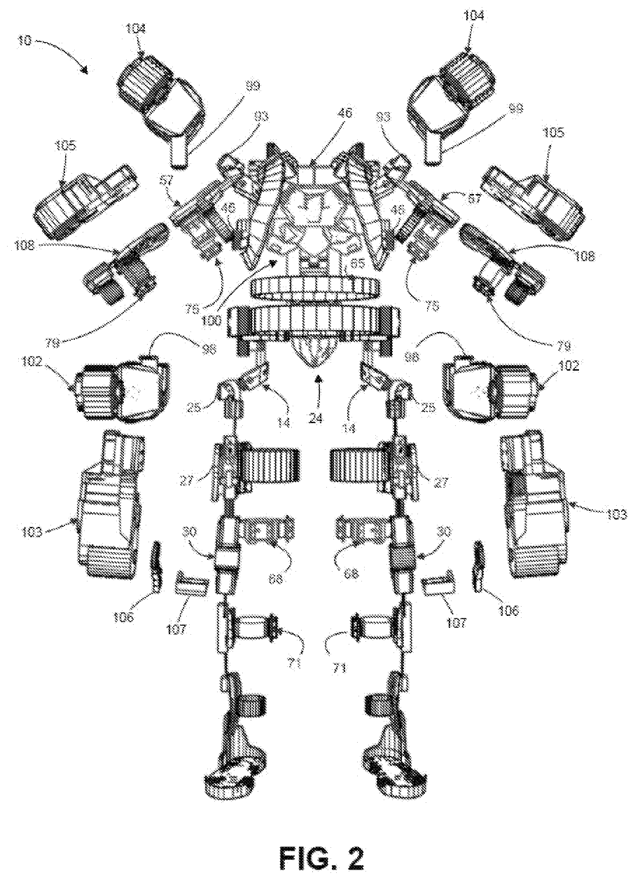

The exoskeleton system 10 of FIGS. 1 and 2 may be generally delineated into two interconnectable segments: (1) an upper extremity (first) frame section 10A, which generally extends from a waist-hip midpoint to a neck base and physically mounts to the user's trunk region; and (2) a lower extremity (second) frame section 10B, which generally extends from the waist-hip midpoint to an ankle or foot region and physically mounts to the legs of a biped. The upper extremity frame section 10A of the exoskeleton system 10 is releasably joined via a hip assembly 14 to the lower extremity frame section 10B. With his arrangement, the exoskeleton system 10 may be readily modified (e.g., without specialized tools or permanently damaging the skeletal structure) for use of just the upper section 10A, just the lower section 10B, or both sections 10A, 10B. The hip assembly 14, in turn, is connected to an outer waist-hip beltloop shell 21, which includes a waist belt 15 that is looped through a central waist belt loop (not visible in the view provided) to secure the upper section 10A to the user's waist. A waist belt loop cover 22 is placed on top of the beltloop shell 21 to secure the waist belt 15; the beltloop shell 21 is then connected via a waist bracket 20 to the hip assembly 14 and a spine unit assembly 58. A waist central unit and a waist bracket unit (not visible in this view) cooperate with waist bracket units 20 to create an adjustable waist support for the exoskeleton system 10.

A lower outer side region of the hip assembly 14 of FIGS. 1 and 2 connects to a pair of (left and right) exoskeleton hip motor adaptors 25, whereas a bottom region of each hip motor adaptor 25 connects to a respective (left or right) exoskeleton thigh assembly 26. An outer side region of each thigh assembly 26 is connected to a respective exoskeleton knee motor adaptor 27, whereas an inner side region of each thigh assembly 26 is connected to a respective femur outer shell 28. The left (first) and right (second) thigh assemblies 26 each employs a respective thigh strap 29 to releasably attach the thigh assemblies 26 and, thus, the lower extremity section 10B to a user's thighs/upper legs. Each thigh assembly 26 is connected to a respective tibial bracket connector 31 via a respective knee assembly 30 and a respective lower-leg upper bracket 96. As will be described in further detail below, the two (left and right) knee assemblies 30 detachably mount thereto knee motor units for mechanization of the user's knee joints. An inner side region of each tibial bracket connector 31 is connected to a respective tibial outer shell 32 that may abut one of the user's tibial regions (e.g., press against the soleus). An optional gas spring (not visible in the views provided) may connect the thigh assembly 26 to the knee assembly 30.

Continuing with the discussion of the exoskeleton's lower extremity section 10B, the two (left and right) tibial bracket connectors 31 are each connected to a respective ankle outer shell 33 via a respective lower-leg bracket 35. The two (left and right) lower-leg brackets 35 are attached to the (left and right) ankle outer shells 33 via respective shin size adjusters 34. Inner side regions of the ankle outer shells 33 are each provided with an ankle strap 95 that wraps around and releasably attaches the ankle outer shells 33 and, thus, the lower extremity section 10B to the user's ankles/lower legs. A bottom outer side region of each ankle outer shell 33 may optionally attach to a respective exoskeleton foot outer shell 36, which seats thereon and operatively attaches to a user's foot/shoe/boot. The two (left and right) ankle outer shells 33 may articulate with respect to the tibial bracket connectors 31, the connectors 31 may articulate with respect to the thigh assemblies 26, and the thigh assemblies 26 may articulate with respect to the hip assembles 14.

To securely attach and selectively detach the lower extremity section 10B to/from the upper extremity section 10A, e.g., for a “full body” exoskeleton architecture, the hip assembly 14 releasably attaches to a bottom end of the spine unit assembly 58 via a socket assembly 23 and a tailbone outer shell 16. This spine unit assembly 58 connects at an upper end thereof to a flexible back plate assembly 38, which may abut a wearer's thoracic spinal (upper back) region. Left and right flanks of the back plate assembly 38 of FIGS. 1 and 2 are provided with respective shoulder outer shell assemblies 53 that each contacts a respective one of the user's shoulders. A respective shoulder harness 47 releasably attaches each shoulder assembly 53 and, thus, the back plate assembly 38 and upper extremity section 10A to the user's left and right shoulders/upper body. In this vein, the two (left and right) shoulder harnesses 47 and the two (left and right) shoulder outer shell assemblies 53 aid in keeping the back plate 38 attached to the user's back. An outer side region of each exoskeleton shoulder assembly 37 attaches to an exoskeleton shoulder motor adaptor 93 for attaching thereto a respective shoulder motor unit. Outer ends of the shoulder assemblies 37 also couple to respective upper arm bracket assemblies 57. Each bracket assembly 57 includes an upper arm strap 94 that wraps around and releasably attaches the shoulder assemblies 37 and, thus, the upper extremity section 10A to the user's humerus/upper arm regions.

To transform the unassisted, passive-type exoskeleton architecture of FIG. 1 to a motor-assisted, active-type exoskeleton architecture, FIG. 2 presents a perspective-view illustration of the modular exoskeleton system 10 of FIG. 1 with a distributed array of motor unit modules that are detachably connected via complementary motor unit connectors to the various motor adaptor sections of the exoskeleton 10. In accord with the illustrated example, a pair of (right and left) hip motor unit modules 102 mount on and drivingly connect to the hip motor adaptors 25 on the lower extremity section 10B of the exoskeleton 10 frame structure. Each modular hip motor unit 102 is equipped with a respective hip rotational bracket 98 that connects the motor unit 102 to the hip assembly 14. In so doing, the motor unit modules 102 are selectively actuable to boost and/or automate movement of the hip assemblies 14 and, thus, the hip joints and legs of the user. Additional information on representative modular motor units, as well as attendant transmission, clutch and control hardware, that may be integrated into the exoskeleton 10 of FIGS. 1 and 2 may be found, for example, in commonly owned U.S. patent application Ser. No. 18/160,356, filed Jan. 27, 2023, and U.S. patent application Ser. No. 18/181,637, filed Mar. 10, 2023, both of which are incorporated herein by reference in their respective entireties and for all purposes.

A pair of (right and left) knee motor unit modules 103 mount on and drivingly connect to the knee motor adaptors 27 via knee motor unit brackets 106. Each mated modular knee motor unit 103 and corresponding bracket 106 securely attach to their respective knee assembly 30 via a knee bracket alignment adaptor 107. In so doing, the motor unit modules 103 are selectively actuable to boost and/or automate movement of the knee assemblies 30 and, thus, the user's knee joints and lower legs. When operated in unison, the motor unit modules 102, 103 may assist with gaited locomotion of a user as well as jumping, squatting, climbing, lifting, etc. It should be appreciated that the exoskeleton 10 of FIG. 2 may employ only one or a select subset of or all four motor units 102, 103 depending, for example, on the intended application of the system.

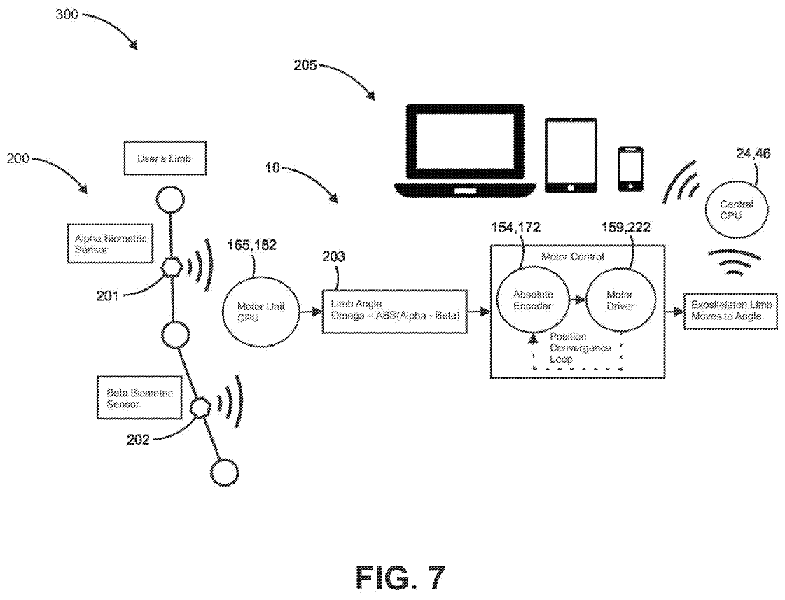

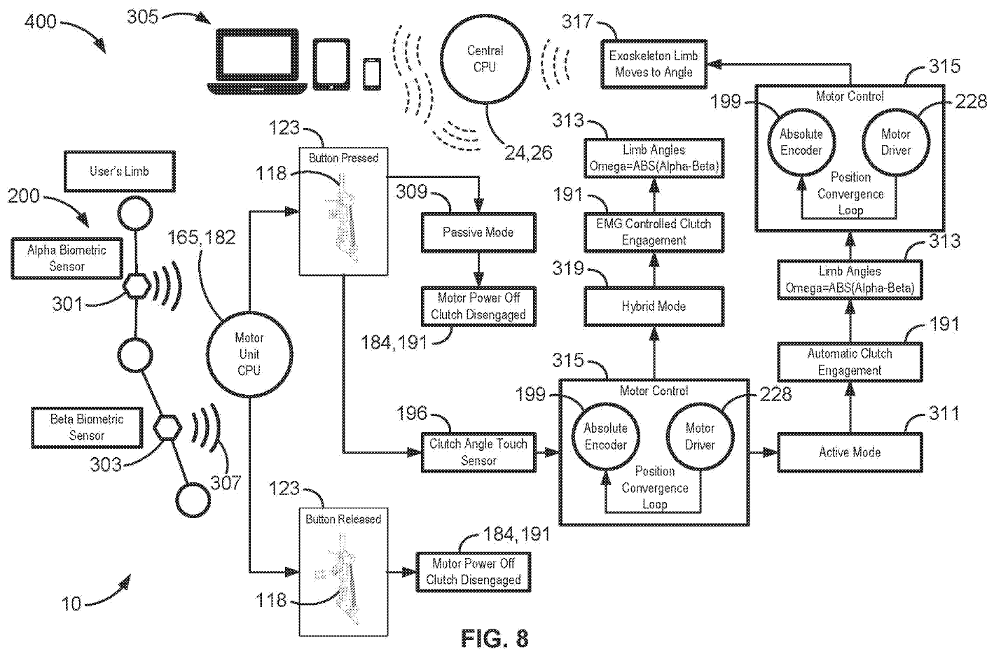

With continuing reference to FIG. 2, a pair of (left and right) shoulder motor unit modules 104 mount on and drivingly connect to the shoulder motor adaptors 93 on the upper extremity section 10A of the exoskeleton 10. Each modular shoulder motor unit 104 is equipped with a respective shoulder rotational bracket 99 that securely connects the motor unit 104 to a back shoulder unit adaptor 45 on the back plate assembly 38. In so doing, the motor unit modules 104 are selectively actuable to boost and/or automate movement of the exoskeleton shoulder assemblies 37 and, thus, the shoulder joints and arms of the user. As described below, e.g., with reference to representative control system architectures illustrated in FIGS. 7 and 8, selective actuation of the illustrated motor modules 102, 103, 104 and 105—individually and collectively—may be by way of a resident or remote controller or network of resident and/or remote controllers, control modules, control circuits, integrated circuit (IC) devices, etc. (collectively referred to herein as “controller”).

A pair of (left and right) elbow motor unit modules 105 mount on and drivingly connect to complementary forearm attachment assemblies 108. Each forearm attachment assembly 108 removably attaches to a user's forearms via straps (as shown). In this regard, each of the herein-described joint and appendage assemblies may employ straps, cables, harnesses, cuffs, or any other suitable means of attachment to operatively mount onto a user. Each of the modular elbow motor units 105 operatively attaches to a respective upper arm bracket assembly 57 on one of the exoskeleton shoulder assemblies 37. In so doing, the motor unit modules 105 are selectively actuable to boost and/or automate movement of the exoskeleton elbow assemblies and, thus, the user's elbow joints and forearms. When operated in unison, the motor unit modules 104, 105 may assist with movement of the upper appendages, e.g., to facilitate lifting, throwing, carrying, gait-related arm swing, etc. It should be appreciated that the exoskeleton 10 of FIG. 2 may employ only one or a select subset of or all four motor units 104, 105 depending, for example, on the intended application of the system.

To govern individual and synchronized operation of the motor unit modules 102, 103, 104, 105, the exoskeleton system 10 may employ a distributed array of sensing devices for actively monitoring real-time or near real-time user variables and system characteristics. The sensing devices may include: (1) a waist biometric sensor assembly 65; (2) a pair of thigh biometric sensor assemblies 68; (3) a pair of lower-leg biometric sensor assemblies 71; (4) a pair of upper arm biometric sensor assemblies 75; and (5) a pair of forearm biometric sensor assemblies 79. A rechargeable energy storage device, such as battery pack 100, may be attached to the back of the back plate assembly 38 and operable to power the exoskeleton's various electronic components. A lower body subsystem CPU 24 provisions input/output (I/O) logic-controlled operation of the sensors, motors, etc., of the lower extremity section 10B, whereas an upper body subsystem CPU 46 provisions I/O logic-controlled operation of the sensors, motors, etc., of the upper extremity section 10A. With this architecture, detachment of the upper extremity exo section 10A from the lower extremity exo section 10A, 10B creates a stand-alone lower body active/passive exoskeleton unit and a stand-alone upper body active/passive exoskeleton unit that may be operated independently from each other. This allows the user to further customize use of the exoskeleton 10 to a myriad of distinct upper and lower body applications. Additional information about the contents, arrangement, and functionality of the exoskeleton system 10 and attendant biometric sensor devices may be found in U.S. Provisional Patent App. Nos. 63/403,425 (hereinafter “'425 Application”) and 63/418,135 (hereinafter “'135 Application”), as well as U.S. patent application Ser. No. 18/298,687, all of which are incorporated herein by reference in their respective entireties and for all purposes.

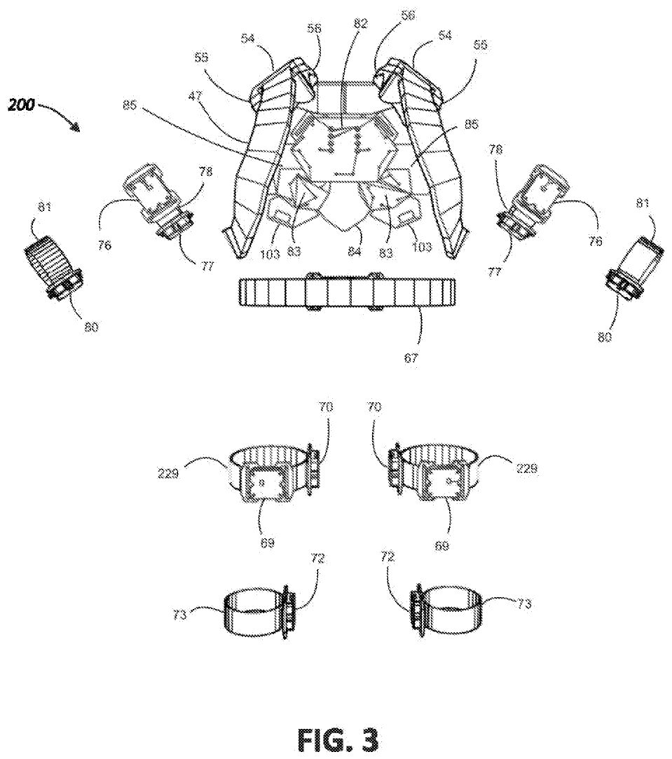

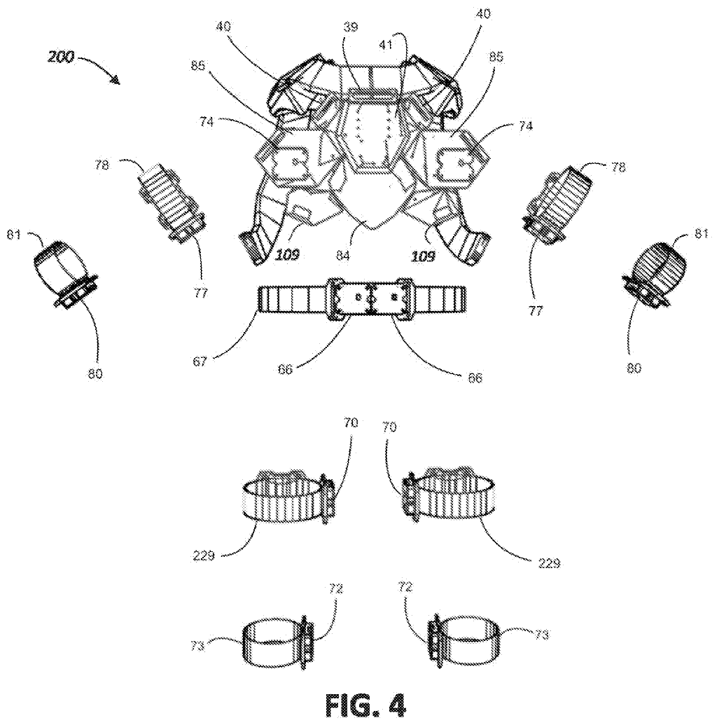

Turning next to FIGS. 3 and 4, there is shown an example of a multimodal, closed-loop feedback biometric sensor system 200 with a distributed network of body-worn biometric sensors. In accord with the illustrated example, the biometric sensor system 200 includes: (1) a waist biometric sensor (beta) module 65; (2) a waist biometric sensor (alpha) motion module 66; (3) a waist biometric sensor strap 67; (4) a pair of (first and second) thigh biometric sensor straps 229; (5) a pair of (first and second) thigh biometric sensor motion (beta) modules 69; (6) a pair of (first and second) thigh biometric sensor (alpha) modules 70; (7) a pair of (first and second) lower-leg biometric sensor motion (beta) modules 72; (8) a pair of (first and second) lower-leg biometric sensor straps 73; (9) a pair of (first and second) upper arm biometric sensor motion (beta) modules 76; (10) a pair of (first and second) upper arm biometric sensor (alpha) modules 77; (11) a pair of (first and second) upper arm biometric sensor straps 78; (12) a pair of (first and second) forearm biometric sensor motion (beta) modules 80; (13) and a pair of (first and second) forearm biometric sensor straps 81. Each biometric sensor may be a wireless-enabled, independently powered electronic sensing device that is operable to collect measurable biological characteristics (biometric data) of a user and output electrical signals indicative thereof. Non-limiting examples of biometric data that may be measured by a biometric sensor include behavioral characteristics, such as velocity, gait, cognitive load, relative angle, etc., and physiological characteristics, such as body temperature, heartrate, perspiration, brain activity, blood flow, etc. It should be appreciated that the biometric sensor system 200 may include greater, fewer, or any combination of the biometric sensor devices shown in FIGS. 3 and 4.

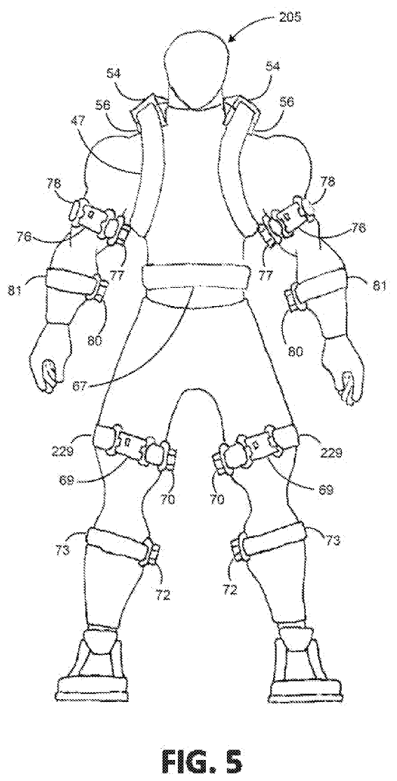

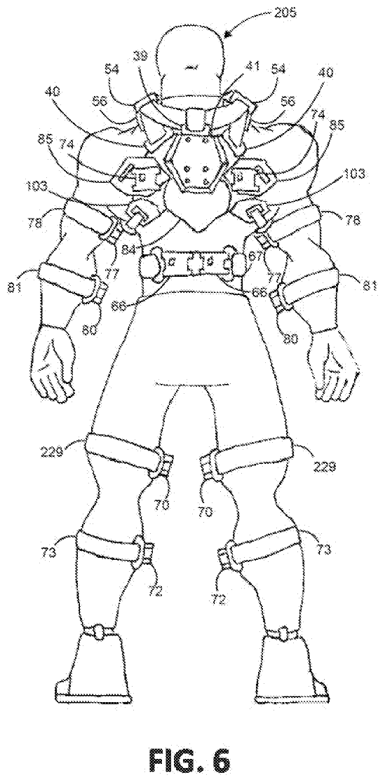

An “alpha” biometric sensor module may measure an upper (first) absolute angle of a subject limb above a joint of interest, and a “beta” biometric sensor module may measure a lower (second) absolute angle of the subject limb below the joint of interest. In order to operate a hip motor unit, for example, a waist alpha biometric sensor may measure a real-time absolute angle of a user's lower back/torso with respect to the ground, and a thigh beta biometric sensor may measure a real-time absolute angle of the user's thigh with respect to the ground. The mounting locations of the various biometric sensor subassemblies, as portrayed in FIGS. 5 and 6, may help to increase the speed and the accuracy of measuring a set of desired biometric characteristics of a limb/joint of interest.

With continuing reference to FIGS. 3 and 4, the waist sensor strap 67 secures the waist biometric sensor modules 65, 66 and, thus, a portion of the biometric sensor system 200 to a user's waist, e.g., in direct physical contact with the user's skin to monitor the user's vital signs (e.g., module 65 measures body temperature (BT), blood pressure (BP), heart rate (HR), respiratory rate (RR), oxygen saturation (OS), blood glucose (BC) level, etc.) and general body movement (e.g., module 66 measures acceleration and velocity in six degrees of freedom (6DoF)). In a similar regard, each thigh sensor strap 229 secures a respective thigh biometric sensor module 70 and a respective thigh biometric sensor motion module 69 to a respective upper-leg (thigh) portion of one of the user's legs, e.g., to monitor that extremity's physiological data (module 70 may measure blood flow and neuromuscular response) and dynamics data (module 69 may measure velocity and acceleration). Each calf sensor strap 73 secures a respective biometric sensor motion module 72 to a respective lower-leg (calf) portion of one of the user's legs, e.g., to monitor dynamics data for that extremity.

Each of the bicep sensor straps 78, like their thigh counterparts described above, secures a respective biometric sensor motion module 76 and a respective biometric sensor module 77 to a respective upper-arm (bicep) portion of one of the user's arms, e.g., to monitor that extremity's physiological data and dynamics data during movement of a user. Each forearm sensor strap 81, like their calf counterparts described above, secures a respective biometric sensor motion module 80 to a respective lower-arm (forearm) portion of one of the user's arms, e.g., to monitor that extremity's dynamic movement. While some of the aforementioned extremity biometric subassemblies are described as having only a biometric motion module and some are described as having both a motion module and a physiology module, it should be appreciated that the individual subassemblies may be modified to include one, both, or more sensor modules, e.g., depending on the intended end-use of the biometric sensor system 200. It is envisioned, for example, that any of the herein described biometric subassemblies may include both proprioceptive and exteroceptive sensors that monitor and output information on the functional status and environment interaction of the user and/or the exo suit.

Performance of networked biometric sensor arrays may be affected by differing environmental and operating conditions. Consequently, biometric sensors may present parametric variances whose operative overlap offer opportunities for sensory fusion. A discrete or embedded sensor fusion control module may execute a fusion algorithm in conjunction with associated memory-stored, application-specific calibration settings to receive sensor data from available sensors, cluster the data into usable estimations and measurements, and fuse the clustered observations to determine, for example, user dynamics and user performance estimates. The fusion algorithm may utilize any suitable sensor fusion method, such as convolutional neural network (CNN) or Kalman Filter (KF) fusion techniques. A KF application may be used to explore correlative characteristics of joints, extremities, and/or appendages along a temporal axis (e.g., assuming that a tracked target moves smoothly over a predefined period of time). Likewise, a KF application may capture spatial correlations, namely the relative position of each target object to a common origin as observed by multiple sensors.

The distributed array of thigh, calf, bicep and forearm biometric sensor subassemblies of the biometric sensor system 200 may wirelessly communicate with a centralized system CPU 46 that is mounted onto the back plate assembly 38 and powered by a rechargeable battery pack 100. The back plate assembly 38 may be fabricated with a flexible and robust center back flex plate 82 that is connected, e.g., via machine screws, to a pair of (left and right) side midback flex plates 83, a pair of (left and right) upper back flex plates 85, and a center midback flex plate 84, all of which may be formed from polyurethane (PU). A pair of adjustable shoulder harnesses 47 pass through respective shoulder strap outer shell 54 located at the top-right and top-left sides of the center back flex plate 82. Top and bottom shell portions 55 and 56, respectively of the shoulder strap outer shell 54 may be made of a flexible polyurethane material and attach together via machine screws.

FIG. 4 is a rear, perspective-view illustration of the biometric sensor system 200 of FIG. 3 to more clearly show some of the attendant sensor components, including the waist biometric sensor motion module 66, upper-back biometric sensor motion modules 74, a center neck loop 39, a back trap loop 40, and a spine primary plate 41. The center neck loop 39 is interposed between and attached to the back trap loop 40 and the spine primary plate 41. The pair of (left and right) upper-back biometric sensor motion modules 74, which flank the opposing lateral sides of the spine primary plate 41, are operable to monitor biometric data for the user (e.g., lung and heart function). As noted above, the waist biometric sensor motion module 66 is mounted onto the waist biometric sensor strap 67. A pair of (left and right) latissimus (lat) loops 109 each connects to the mid back flex plate 83 and center mid back flex plate 84 via machine screws.

Turning next to FIGS. 5 and 6, the biometric sensor system 200 is shown being worn by a representative user 205. As shown in this example, the biometric subassembly straps 67, 73, 78, 81 and 229 may be designed to “form-fit” mount onto the human body for a secure and conforming attachment to the user to thereby prevent inadvertent movement on the user's limbs when the user is moving. During system operation, EMG signals may be collected by motor unit CPUs every time the user 205 moves his or her appendages and joint angles. The wireless biometric sensor subassemblies help to eliminate sensor-to-sensor and sensor-to-CPU wired connections wires that may interface with operation of an exoskeleton; doing so helps to simplify the design and manufacture of disclosed exo and biometric sensor systems.

FIG. 7 provides a diagrammatic illustration of a representative wireless biometric sensor-to-motor unit control system and method, collectively designated as 300. In this example, an alpha biometric sensor 201 and a beta biometric sensor 202, which may take on any of the form factors, features, and options presented in FIGS. 3-6, collect biometric measurements from a user wearing the exoskeleton system 10 of FIGS. 1 and 2 and/or the biometric sensor system 200 of FIGS. 3 and 4. When one of the motor unit CPUs 165, 182 subscribes to the wireless transmission of sensor data from one or both biometric sensors 201, 202, it may responsively calculate a limb joint angle omega from the received alpha (first) and beta (second) sensor signals, as indicated at process block 203:

Omega=|alpha−beta|

where alpha is an absolute angle from an alpha biometric sensor module, and beta is an absolute angle from a beta biometric sensor module, as described above. After the calculation of limb joint angle omega, the motor unit CPUs 165, 182 use the limb joint angle as an input for motor control.

Upon receipt of joint angle omega generated by motor unit CPUs 165, 182, an absolute position encoder 154, 172 determines a current position of an electric motor 145, 167, such as a brushless direct-current (DC) motor within one or more of the motor unit modules 102, 103, 104, 105. The corresponding motor unit CPU 165, 182 transmits command signals to a motor driver 159, 222 to move the motor 145, 167 in a direction corresponding to a defined location of an omega set point. This process may systematically repeat in a position convergence loop until a position convergence is achieved. When position convergence is achieved, the motor unit has successfully moved to the omega joint angle set point. A result of this control process may include real-time movement of an exoskeleton limb to assist a user's action. An output movement signal may be sent via wireless transmission to a central CPU (e.g., lower body subsystem CPU 24 or upper body subsystem CPU 46) for processing. Commensurate data may be concurrently sent via wireless transmission from the central CPU to an IoT device, such as a phone, tablet, computer app, etc., (collectively 205 in FIG. 12), e.g., for logging, storage, data display, and analysis.

With reference next to FIG. 8, there is shown a diagrammatic illustration of a representative wireless biometric sensor array, which may be comparable in hardware and architecture to the biometric sensor system 200, networked with a control system and method 400 for automated hybrid motor-unit-motor-clutch (MUMC) control for an exoskeleton system, such as exoskeleton system 10. In this example, an alpha biometric sensor or sensors 301 and a beta biometric sensor or sensors 303 collect biometric measurements from a user, e.g., that is wearing the exoskeleton suit 10A, 10B or the biometric sensor system 200. These sensors 301, 303 measure, convert, and transmit biometer data as sensor signals via wireless communication to one or more of the motor unit CPUs 165, 182. Using a smartphone, tablet computer, or other wireless-enabled personal computing device, app, or interface (collectively designated 305 in FIG. 8), a user may input a desired operating mode—active, passive or hybrid—that may be enabled when a motor-clutch button switch 123 is pressed. As described in the related applications that are incorporated herein by reference, the exoskeleton thigh assembly 26 or other exo appendage assembly may include a magnetic locking device 118 that contains a motor/clutch button switch 123 that is selectively actuable to govern operation of a corresponding modular motor unit.

If a passive (disengaged) operating mode 309 is selected by a user or system operator, the electric motor 184 and its torque-transmitting clutch 191 mechanism may be powered off or maintained in an off state such that the motor 184 does not generate assist torque and the clutch 191 is disengaged or remains disengaged. This passive operating mode may allow the user to freely move around with limited or no assistance from the motor 184. Comparatively, if an active (engaged) operating mode 311 is selected by the user or the system operator, the motor 184 and clutch 191 may be powered on and maintained in an on state of operation; in so doing, the clutch angle touch sensor 196 may be used as an input for automated alignment and control of the motor unit 184. When the clutch 191 is engaged (i.e., takes up a torque-carrying capacity), the alpha and beta biometric sensors 301, 303 may output (advertise) wireless angle data.

When one or more of the motor unit CPUs 165, 182 subscribes to the wireless transmission of sensor data from one or more of the biometric sensors 301, 303, e.g., as indicated at process block 307, it may responsively calculate a limb joint angle omega, as indicated at process block 313 (Omega=| (Alpha Angle)−(Beta Angle)|). After the calculation of omega, the motor unit CPUs 165, 182 use the limb joint angle as an input for motor control at process block 315. The absolute encoder 199 may then determine a real-time or near real-time angular position of the motor 184; the motor unit CPU 165, 182 may responsively transmit command signals to the motor driver 199, 228 to move the motor 145, 167 in a direction corresponding to an omega set point. As noted above, this process may systematically repeat until a position convergence is achieved.

Using the above-noted motor control system and method may help to provision real-time automated movement of an exoskeleton limb or limbs to assist or provide a desired user movement. At process block 317, an output movement signal may be sent via wireless transmission to the Central CPU (e.g., CPU 24 and/or CPU 46) for processing; corresponding data may be sent via wireless transmission to an IoT device or a smartphone, tablet computer, or computer app for data display and logging. If the user selects hybrid mode at process block 319, the clutch angle touch sensor 196 angle may be used as an input for continuous motor control as if the motor is following the clutch position. When an EMG threshold on the biometric sensors is reached, the clutch may engage and the active mode process described may be executed. If the motor-clutch button is released, the motor 184 may be powered off and/or the clutch 191 disengaged; at this juncture, a joint and appendage assembly may be locked in place.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the disclosure expressly includes any and all combinations and subcombinations of the preceding elements and features.

What is claimed:

1. A biometric sensor system, comprising:
a first biometric subassembly configured to mount to an upper-extremity portion of a first appendage of a user, the first biometric subassembly including a first biometric sensor operable to monitor a first biometric characteristic of the upper-extremity portion of the first appendage and wirelessly output a first sensor signal indicative thereof;
a second biometric subassembly configured to mount to a lower-extremity portion of the first appendage of the user, the second biometric subassembly including a second biometric sensor operable to monitor a second biometric characteristic of the lower-extremity portion of the first appendage and wirelessly output a second sensor signal indicative thereof; and
a system central processing unit (CPU) configured to mount onto the user and wirelessly communicate with the first and second biometric subassemblies, the system CPU being programmed to:
receive the first sensor signal from the first biometric sensor and the second sensor signal from the second biometric sensor;
calculate a first biometric parameter of the first appendage using the first and second biometric characteristics indicated by the first and second sensor signals received from the first and second biometric sensors; and
transmit a command signal to a subsystem to execute a control operation based on the calculated first biometric parameter.

2. The biometric sensor system of claim 1, wherein the first biometric characteristic is a first relative angle, the second biometric characteristic is a second relative angle, and the first biometric parameter of the first appendage is a joint angle of a joint of the first appendage.

3. The biometric sensor system of claim 2, wherein the joint angle is calculated as an absolute value of a mathematical difference between the first and second relative angles.

4. The biometric sensor system of claim 1, wherein the system CPU is further programmed to:
receive a selection of a desired operating mode for the subsystem, the desired operating mode being selected from a group comprising an active mode and a passive mode; and
responsive to the desired operating mode being the active mode, transmit a power-on command signal to the subsystem to transition to an active operating state.

5. The biometric sensor system of claim 1, wherein the subsystem includes an electric motor, a position encoder, and a motor driver, and wherein the control operation includes the position encoder determining a current position of the electric motor and the motor driver changing the current position of the electric motor based on the calculated first biometric parameter.

6. The biometric sensor system of claim 5, wherein the control operation further includes the motor driver moving the electric motor to an omega set point via systematically repeating a position convergence loop until a position convergence is achieved between the current position of the electric motor and the omega set point.

7. The biometric sensor system of claim 5, wherein the subsystem further includes a torque-transmitting clutch mechanism drivingly connected to the electric motor, and wherein the control operation further includes activating the clutch mechanism to transmit torque received from the electric motor.

8. The biometric sensor system of claim 1, wherein the first biometric sensor of the first biometric subassembly includes a biometric sensor motion module operable to monitor one or more dynamic characteristics of the first appendage and a biometric sensor module operable to monitor one or more physiological characteristics of the first appendage.

9. The biometric sensor system of claim 1, further comprising a rechargeable energy storage device configured to mount onto the user and selectively power the system CPU.

10. The biometric sensor system of claim 1, further comprising a waist biometric subassembly configured to mount to a waist portion of the user, the waist biometric subassembly including a biometric sensor operable to monitor a biometric characteristic of the waist portion of the user and wirelessly output a sensor signal indicative thereof to the system CPU.

11. The biometric sensor system of claim 1, further comprising:
a third biometric subassembly configured to mount to an upper-extremity portion of a second appendage of the user, the third biometric subassembly including a third biometric sensor operable to monitor a third biometric characteristic of the upper-extremity portion of the second appendage and wirelessly output a third sensor signal indicative thereof to the system CPU; and
a fourth biometric subassembly configured to mount to a lower-extremity portion of the second appendage, the fourth biometric subassembly including a fourth biometric sensor operable to monitor a fourth biometric characteristic of the lower-extremity portion of the second appendage and wirelessly output a fourth sensor signal indicative thereof to the system CPU.

12. The biometric sensor system of claim 1, wherein the first biometric subassembly includes a first strap mounting thereto the first biometric sensor, the second biometric subassembly includes a second strap mounting thereto the second biometric sensor, the first strap being shaped and sized to immovably mount onto the upper-extremity portion of the first appendage, and the second strap being shaped and sized to immovably mount onto the lower-extremity portion.

13. The biometric sensor system of claim 1, wherein the first appendage is an arm or a leg, the upper-extremity portion to which mounts the first biometric subassembly includes a bicep portion of the arm or a thigh portion of the leg, and the lower-extremity portion to which mounts the second biometric subassembly includes a forearm portion of the arm or a tibia portion of the leg.

14. An exoskeleton system comprising:
an exoskeleton frame with a joint assembly configured to attach to an appendage of a user;
a motor unit removably attached to the exoskeleton frame and selectively operable to transmit a motor torque to the joint assembly to thereby assist with movement of the appendage of the user; and
a biometric sensor system, including:
a first biometric subassembly configured to mount to an upper-extremity portion of the appendage and including a first biometric sensor operable to monitor a first biometric characteristic of the upper-extremity portion and wirelessly output a first sensor signal indicative thereof;
a second biometric subassembly configured to mount to a lower-extremity portion of the appendage and including a second biometric sensor operable to monitor a second biometric characteristic of the lower-extremity portion and wirelessly output a second sensor signal indicative thereof; and
a system central processing unit (CPU) configured to mount onto the user and wirelessly communicate with the first and second biometric subassemblies, the system CPU being programmed to:
receive the first sensor signal from the first biometric sensor and the second sensor signal from the second biometric sensor;
calculate a first biometric parameter of the first appendage using the first and second biometric characteristics indicated by the first and second sensor signals received from the first and second biometric sensors; and
transmit a command signal to the motor unit to output a motor torque and thereby change a motor position based on the calculated first biometric parameter.

15. A method of operating a biometric sensor system for a user with multiple appendages, the method comprising:
mounting a first biometric subassembly to an upper-extremity portion of a first appendage of the user appendages, the first biometric subassembly including a first biometric sensor operable to monitor a first biometric characteristic of the upper-extremity portion of the first appendage and wirelessly output a first sensor signal indicative thereof;
mounting a second biometric subassembly to a lower-extremity portion of the first appendage, the second biometric subassembly including a second biometric sensor operable to monitor a second biometric characteristic of the lower-extremity portion of the first appendage and wirelessly output a second sensor signal indicative thereof;
mounting a system central processing unit (CPU) onto the user;
receiving, via the system CPU, the first sensor signal from the first biometric sensor and the second sensor signal from the second biometric sensor;
calculating, via the system CPU, a first biometric parameter of the first appendage using the first and second biometric characteristics indicated by the first and second sensor signals received from the first and second biometric sensors; and
transmitting, via the system CPU to a subsystem, a command signal to execute a control operation based on the calculated first biometric parameter.

16. The method of claim 15, wherein the first biometric characteristic is a first relative angle, the second biometric characteristic is a second relative angle, and the first biometric parameter of the first appendage is a joint angle of a joint of the first appendage.

17. The method of claim 16, wherein the joint angle is calculated as an absolute value of a mathematical difference between the first and second relative angles.

18. The method of claim 15, wherein the subsystem includes an electric motor, a position encoder, and a motor driver, and wherein the control operation includes the position encoder determining a current position of the electric motor and the motor driver changing the current position of the electric motor based on the calculated first biometric parameter.

19. The method of claim 18, wherein the control operation further includes the motor driver moving the electric motor to an omega set point via systematically repeating a position convergence loop until a position convergence is achieved between the current position of the electric motor and the omega set point.

20. The method of claim 18, wherein the subsystem further includes a torque-transmitting clutch mechanism drivingly connected to the electric motor, and wherein the control operation further includes activating the clutch mechanism to transmit torque received from the electric motor.
